(19) United States
(12) Patent Application Publication
(10) Pub. No.: US 2024/0039718 A1
(43) Pub. Date: Feb. 1, 2024

(54) RECOVERY VERIFICATION SYSTEM, COLLATION SYSTEM, RECOVERY VERIFICATION METHOD, AND NON-TEMPORARY COMPUTER READABLE MEDIUM

(71) Applicant: NEC Corporation, Minato-ku, Tokyo (JP)

(72) Inventors: Masahiro NARA, Tokyo (JP); Toshihiko OKAMURA, Tokyo (JP); Toshiyuki ISSHIKI, Tokyo (JP); Hiroto TAMIYA, Tokyo (JP)

(73) Assignee: NEC Corporation, Minato-ku, Tokyo (JP)

(21) Appl. No.: 18/265,726

(22) PCT Filed: Dec. 16, 2020
(86) PCT No.: PCT/JP2020/046917

§ 371 Date: Jun. 7, 2023

(51) Int. Cl. H04L 9/08; H04L 9/32; H04L 9/30

(52) U.S. Cl. CPC H04L 9/0894; H04L 9/3231; H04L 9/0869; H04L 9/30

(57) ABSTRACT

In a recovery verification system, a template storage unit stores a template acquired by encrypting registration input information being biometric information about a registrant by using a secret key. A random number generation unit generates a random number in response to a request from the client. A protected template generation unit conceals the template by the random number, and transmits a protected template to the client. A determination unit acquires, from the client, information about a concealment index that is acquired by concealing a degree of similarity between registration input information and collation information being biometric information about an authenticated subject and is calculated based on the collation information and the protected template. A determination unit generates an index acquired by decrypting the concealment index by using a public key associated with the secret key and the random number, and performs authentication, based on the index.

### TECHNICAL FIELD

The present disclosure relates to a recovery verification system, a collation system, a recovery verification method, and a non-transitory computer-readable medium.

### BACKGROUND ART

When a client logs into a server system, authentication processing of collating registration information (secret information) about a user being a client registered in advance and information being input from the user is performed (see Patent Literatures 1, 2, 3, and 4).

Then, in such a system, when the user loses secret information to be used for authentication, processing (account recovery) of recovering access authority is performed. Herein, in Non Patent Literature 1 issued by a fast ID entity online (FIDO) alliance, it is recommended that a template is registered in advance in a plurality of clients, an IC card, and the like. In this way, the user can be less likely to completely lose secret information to be used for authentication, and the number of times an account recovery is performed can be reduced.

Furthermore, in Non Patent Literature 1, two methods are described as an account recovery method when the user loses all templates. The first method is a method for performing identification similar to that at a time of template registration, and the second method is a method for registering authentication information for an account recovery in advance in a server, and performing identification by using the authentication information. The first method includes a method for performing confirmation of an identification card such as a driver's license, for example. Further, the second method includes a method for transmitting a recovery code to a phone number or a mail address being registered in advance, and confirming the recovery code.

### CITATION LIST

### Patent Literature

[Patent Literature 1] Japanese Unexamined Patent Application Publication No. 2011-211593
[Patent Literature 2] Japanese Unexamined Patent Application Publication No. 2009-129292
[Patent Literature 3] International Patent Publication No. WO2018/110608
[Patent Literature 4] International Patent Publication No. WO2020/121461

### Non Patent Literature

[Non Patent Literature 1] Hidehito GOMI, Bill Leddy, Dean H. Saxe, “Recommended Account Recovery Practices for FIDO Relying Parties”, FIDO Alliance, 2019

### SUMMARY OF INVENTION

### Technical Problem

As the account recovery, the method for performing identification by an identification card generally has a low level of convenience, and the method for performing identification by a recovery code generally has a low level of safety.

In order to achieve both convenience and safety, use of biometric authentication for the account recovery has been proposed. However, when biometric authentication is used for the account recovery in general, a biometric feature value being personal information needs to be kept as a template in a verification server at a time of the account recovery. Therefore, when a template leaks out due to a cyber attack by malware and the like, misbehavior of a supervisor, and the like, a risk that a biometric feature value being unchangeable throughout a lifetime may leak out. Therefore, there is a problem that a template used for biometric authentication needs to be strictly protected also in authentication at a time of the account recovery.

The present disclosure has been made in order to solve such a problem, and an object of the present disclosure is to provide a recovery verification system, a collation system, a recovery verification method, and a non-transitory computer-readable medium that have high levels of convenience and safety.

### Solution to Problem

A recovery verification system according to one aspect of the present disclosure includes: a template storage means, a random number generation means, a protected template generation means, and a determination means. The template storage means stores a template acquired by encrypting registration input information being biometric information about a registrant by using a secret key. The random number generation means generates a random number in response to a request from a client. The protected template generation means generates a protected template acquired by protecting the template by using the random number, and transmits the protected template to the client. The determination means acquires, from the client, information about a concealment index that is an index acquired by concealing a degree of similarity between registration input information and collation information being biometric information about an authenticated subject and is calculated based on the collation information and the protected template. Then, the determination means generates an index acquired by decrypting the concealment index by using a public key associated with the secret key and the random number, and performs authentication on the collation information, based on whether the generated index indicates a value within a predetermined range.

A collation system according to one aspect of the present disclosure includes: a client; a normal verification system, and a recovery verification system. The normal verification system performs authentication on normal collation information being input for collation with normal registration input information about a registrant. The recovery verification system is a system for recovering an account related to the normal registration input information about the registrant. The recovery verification system includes: a template storage means, a random number generation means, a protected template generation means, and a determination means. The template storage means stores a template acquired by encrypting recovery registration input information being biometric information about the registrant by using a secret key. The random number generation means generates a random number in response to a request from the client. The protected template generation means generates a protected template acquired by concealing the template by using the random number, and transmits the protected template to the client. The determination means acquires, from the client, information about a concealment index that is an index acquired by concealing a degree of similarity between recovery registration input information and recovery collation information being biometric information about an authenticated subject and is calculated based on the recovery collation information and the protected template. Then, the determination means generates an index acquired by decrypting the concealment index by using a public key associated with the secret key and the random number, and performs authentication on the recovery collation information, based on whether the generated index indicates a value within a predetermined range.

A recovery verification method according to one aspect of the present disclosure includes: a random number generation stage; a protected template generation stage; an acquisition stage; and an authentication stage. The random number generation stage is a stage of generating a random number in response to a request from a client. The protected template generation stage is a stage of generating a protected template acquired by concealing a template by using the random number, and transmitting the protected template to the client. The template is acquired by encrypting registration input information being biometric information about a registrant by using a secret key. The acquisition stage is a stage of acquiring, from the client, information about a concealment index. The concealment index is an index acquired by concealing a degree of similarity between registration input information and collation information being biometric information about an authenticated subject, and is calculated based on the collation information and the protected template. The authentication stage is a stage of generating an index acquired by decrypting the concealment index by using a public key associated with the secret key and the random number, and performing authentication on the collation information, based on whether the generated index indicates a value within a predetermined range.

A non-transitory computer-readable medium according to one aspect of the present disclosure causes a computer to execute: random number generation processing; protected template generation processing; acquisition processing; and authentication processing. The random number generation processing is processing of generating a random number in response to a request from a client. The protected template generation processing is processing of generating a protected template acquired by concealing a template by using the random number, and transmitting the protected template to the client. The template is acquired by encrypting registration input information being biometric information about a registrant by using a secret key. The acquisition processing is processing of acquiring, from the client, information about a concealment index. The concealment index is an index acquired by concealing a degree of similarity between registration input information and collation information being biometric information about an authenticated subject, and is calculated based on the collation information and the protected template. The authentication processing is processing of generating an index acquired by decrypting the concealment index by using a public key associated with the secret key and the random number, and performing authentication on the collation information, based on whether the generated index indicates a value within a predetermined range.

### Advantageous Effects of Invention

The present disclosure can provide a recovery verification system, a collation system, a recovery verification method, and a non-transitory computer-readable medium that have high levels of convenience and safety since collation is performed while a template is protected with biometric authentication as a basis.

### BRIEF DESCRIPTION OF DRAWINGS

FIG. 1 is a block diagram illustrating a functional configuration of a recovery verification system according to a first example embodiment;

FIG. 2 is a schematic configuration diagram illustrating a collation system to which the recovery verification system can be applied;

FIG. 3 is a schematic configuration diagram of a normal collation system according to a second example embodiment;

FIG. 4 is a schematic configuration diagram of a recovery collation system according to the second example embodiment;

FIG. 5 is a sequence diagram illustrating a procedure of registration processing of the normal collation system according to the second example embodiment;

FIG. 6 is a sequence diagram illustrating a procedure of the normal collation system according to the second example embodiment;

FIG. 7 is a sequence diagram illustrating a procedure of recovery registration processing of the recovery collation system according to the second example embodiment;

FIG. 8 is a sequence diagram illustrating a procedure of recovery authentication processing of the recovery collation system according to the second example embodiment; and

FIG. 9 is a schematic block diagram illustrating a configuration example of a computer according to a client and a server in the present example embodiment and a specific example thereof.

### EXAMPLE EMBODIMENT

The present disclosure will be described below with reference to the example embodiments, but the present disclosure in the claims is not limited to the example embodiments below. Further, all configurations described in the example embodiments are not necessarily essential as a means for solving the problem. For clarification of the description, the description and the drawings below are appropriately omitted and simplified. Note that, the same element is denoted by the same reference sign in each of the drawings.

### <Challenge of Example Embodiment>

Herein, a challenge desired to be solved by the present example embodiment will be described again.

One example of authentication is biometric authentication. The “biometric authentication” is a technique of personal authentication for confirming whether a registrant and an authenticated subject coincide with each other by comparing biometric information about the registrant with biometric information about the authenticated subject. Further, the “biometric information” is data being extracted from a part of features related to a body and behavior, or data being generated by converting the extracted data. The data may also be referred to as a feature value. Herein, data that include data generated by biometric information (hereinafter referred to as registration information) about a registrant and are stored in advance for biometric authentication are referred to as a template.

When biometric authentication is performed by a client-server system, there are an aspect in which a template is stored in a client and an aspect in which the template is stored in a server.

Patent Literature 1 and Patent Literature 2 described above describe one example of an authentication device and an authentication method in which registration information does not leak out by storing encrypted registration information as a template in a server. Further, Patent Literature 3 described above describes a collation system for increasing safety related to a binary vector.

Examples of aspects for storing a template in a client include a fast ID entity online (FIDO) authentication method. In the FIDO authentication method, a template is stored in advance in a client. Then, when biometric information of a user (authenticated subject) who currently uses the client is input to the client, the client determines whether the authenticated subject corresponds to a registrant by the input biometric information and the template. Then, when the client determines that the authenticated subject corresponds to the registrant, a server determines whether a signing key (secret key) of the client and a verification key (public key) of the server are a pair of keys, based on a digital signature generated by the signing key by the client. In other words, in the FIDO authentication method, when biometric authentication succeeds in the client and verification of a signature of the client succeeds in the server, it is determined that authentication of the user (authenticated subject) succeeds at the end.

Further, in the FIDO authentication method, data including information acquired by encrypting biometric information about a registrant are stored as a template in advance in a client. Then, a key for decrypting the encrypted information is also stored in the client. When biometric information about an authenticated subject is input, the client decrypts a cryptogram of the biometric information included in the template by using the key, and whether the authenticated subject corresponds to a registrant is determined by using the decrypted biometric information and the input biometric information.

Patent Literature 4 discloses a collation system in which a template is stored in a client, the client calculates a concealment index acquired by concealing an index indicating similarity between the template and collation information, and a server performs authentication, based on the concealment index.

Further, encrypted biometric information may be stored in an IC chip of an integrated circuit (IC) card.

In an authentication system, when a user loses secret information to be used for authentication, an account recovery for recovering access authority is needed. In Non Patent Literature 1 issued by the FIDO alliance, two methods are described as an account recovery method when a user loses all templates. However, as described above, there is a challenge in terms of convenience or safety.

In order to achieve both convenience and safety, use of biometric authentication for an account recovery has been proposed, but, as described above, an improvement in safety has been required in order to reduce a leakage risk of a template.

As described, a challenge of achieving both convenience and safety is present in an account recovery. The present disclosure has been made in view of such a challenge, and example embodiments will be described below.

### First Example Embodiment

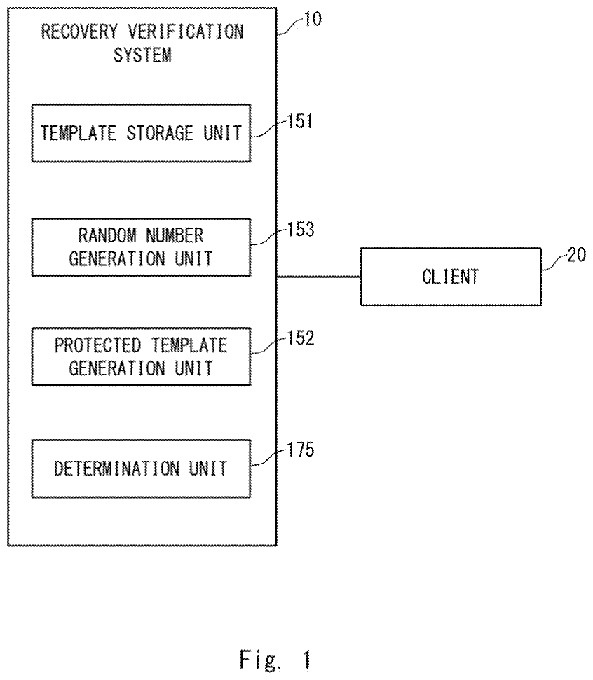

First, a first example embodiment according to the present disclosure will be described by using FIG. 1. FIG. 1 is a block diagram illustrating a functional configuration of a recovery verification system 10 according to the first example embodiment. The recovery verification system 10 is a computer system for performing authentication for an account recovery. The recovery verification system 10 is communicably connected to a client 20. The client 20 is a computer device or a computer system used for authentication by an authenticated subject.

The recovery verification system 10 includes a template storage unit 151, a random number generation unit 153, a protected template generation unit 152, and a determination unit 175.

The template storage unit 151 stores a template. The template is information acquired by encrypting registration input information by using a secret key. The registration input information is biometric information about a registrant being input by the registrant for user registration for an account recovery.

The random number generation unit 153 generates a random number in response to an account recovery request from the client 20.

The protected template generation unit 152 conceals the template stored in the template storage unit 151 by using the random number generated by the random number generation unit 153, and generates a protected template as the result. Then, the protected template generation unit 152 transmits the generated protected template to the client 20.

The determination unit 175 acquires information about a concealment index from the client 20. Then, the concealment index is an index acquired by concealing a degree of similarity between registration input information and collation information. The collation information is biometric information about an authenticated subject being input by the authenticated subject for user registration for an account recovery. The concealment index is calculated based on collation information and a protected template in the client 20.

Next, the determination unit 175 generates an index acquired by decrypting a concealment index by using a public key associated with a secret key and the random number generated by the random number generation unit 153. Then, the determination unit 175 performs authentication on the collation information, based on whether the generated (decrypted) index indicates a value within a predetermined range. For example, the determination unit 175 accepts authentication of the collation information when the generated index indicates a value within the predetermined range.

In this way, according to the first example embodiment, the recovery verification system 10 is based on biometric authentication, and thus has convenience to the same extent as that of biometric authentication. Further, the recovery verification system 10 performs collation processing while protecting a template. At this time, the recovery verification system 10 provides, to a client, a template protected by a random number generated in response to a request from the client, i.e., a different random number for each request, and thus a leakage risk of biometric information is small and safety is high. By adopting such a system having high levels of convenience and safety for an account recovery, a management cost for the account recovery can be reduced.

### Second Example Embodiment

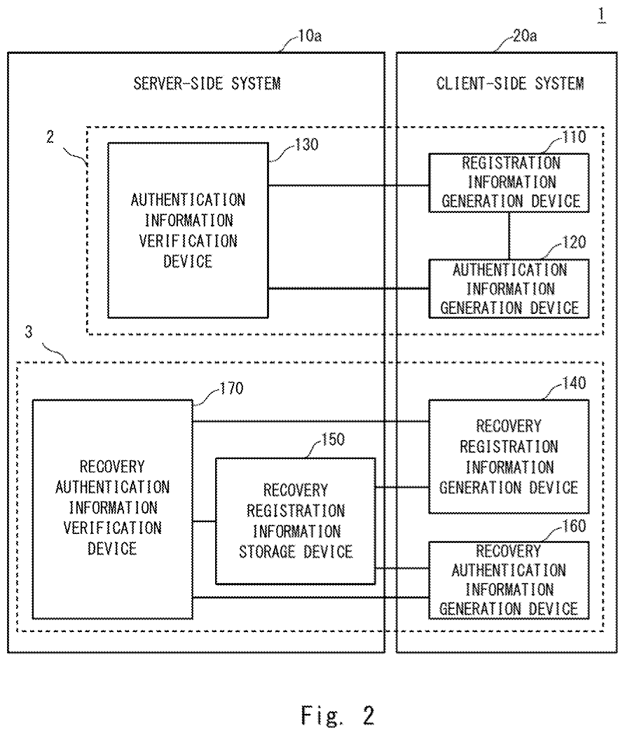

Next, a second example embodiment according to the present disclosure will be described by using FIGS. 2 to 8. FIG. 2 is a schematic configuration diagram illustrating a collation system 1 to which a recovery verification system can be applied. The collation system 1 includes a server-side system 10a and a client-side system 20a.

The server-side system 10a is a server-side computer system. The server-side system 10a includes an authentication information verification device 130, a recovery registration information storage device 150, and a recovery authentication information verification device 170.

The client-side system 20a is a client-side computer system, and is associated with the client 20 according to the first example embodiment. The client-side system 20a includes a registration information generation device 110, an authentication information generation device 120, a recovery registration information generation device 140, and a recovery authentication information generation device 160.

The registration information generation device 110, the authentication information generation device 120, and the authentication information verification device 130 are a computer device constituting a normal collation system 2. The normal collation system 2 is a collation system for performing normal registration processing and normal authentication processing. The devices in the normal collation system 2 are communicably connected to each other.

The registration information generation device 110 generates normal registration information about a registrant to be used in the normal authentication processing, and registers the normal registration information. In other words, the registration information generation device 110 performs the normal registration processing. Herein, the normal registration information is information acquired by encrypting secret information about a registrant, which is a so-called normal template. For example, the secret information may be text data such as a password, or biometric information about a registrant, which is not limited thereto. Further, the registrant may be a user of the client-side system 20a.

The authentication information generation device 120 generates normal authentication information by using the normal registration information about the registrant and normal collation information about an authenticated subject. Herein, the normal collation information is information being input by the authenticated subject for collation with the normal registration information about the registrant. Further, the normal authentication information is information to be a material for determining whether normal authentication is accepted, and is information indicating a degree of similarity between the normal registration information and the normal collation information, for example.

The authentication information verification device 130 verifies the normal authentication information, and performs authentication on the normal collation information as the result. Note that the authentication information verification device 130 is also called a normal verification system.

The recovery registration information generation device 140, the recovery registration information storage device 150, the recovery authentication information generation device 160, and the recovery authentication information verification device 170 are a computer device constituting a recovery collation system 3. The recovery collation system 3 is a collation system for performing recovery registration processing and recovery authentication processing for recovering an account related to the normal registration information about the registrant.

The recovery registration information generation device 140 generates, by using a secret key, recovery registration information about the registrant to be used in the recovery authentication processing. The recovery registration information is information acquired by encrypting, by a secret key, registration input information for a recovery (recovery registration input information) being biometric information about the registrant. In other words, the recovery registration information is associated with the template according to the first example embodiment. The recovery registration information generation device 140 is communicably connected to the recovery registration information storage device 150 and the recovery authentication information verification device 170. The recovery registration information generation device 140 transmits the recovery registration information to the recovery registration information storage device 150, and transmits a public key associated with the secret key to the recovery authentication information verification device 170.

The recovery registration information storage device 150 stores the recovery registration information. The recovery registration information storage device 150 generates a random number in response to a request from the recovery authentication information generation device 160, and generates a random number mask. The recovery registration information storage device 150 generates recovery information by using the recovery registration information and the generated random number mask. The recovery information is associated with the protected template according to the first example embodiment. The recovery registration information storage device 150 transmits the recovery information to the recovery authentication information generation device 160.

The recovery authentication information generation device 160 generates recovery authentication information by using the recovery information and recovery collation information that is biometric information about the authenticated subject being input by the authenticated subject. The recovery collation information is associated with the collation information according to the first example embodiment. Further, the recovery authentication information includes information about a concealment index acquired by concealing a degree of similarity between recovery registration input information and recovery collation information. The recovery authentication information generation device 160 transmits the recovery authentication information to the recovery authentication information verification device 170.

The recovery authentication information verification device 170 verifies the recovery authentication information by using the public key and the random number mask in order to recover the account related to the normal registration information about the registrant, and performs authentication on the recovery collation information as the result.

Further, the recovery registration information storage device 150 and the recovery authentication information verification device 170 are associated with the recovery verification system 10 according to the first example embodiment.

Various functions of the authentication information verification device 130, the recovery registration information storage device 150, and the recovery authentication information verification device 170 constituting the server-side system 10a may be implemented by a single device, or may be implemented by a plurality of devices. The same also applies to the registration information generation device 110, the authentication information generation device 120, the recovery registration information generation device 140, and the recovery authentication information generation device 160 constituting the client-side system 20a. Note that the registration information generation device 110 may be included in the server-side system 10a instead of the client-side system 20a.

Next, details of the normal collation system 2 and the recovery collation system 3 will be described, but, when processing performed in the normal collation system 2 and information used in the processing are indicated, “normal” may be omitted below. Note that, in the second example embodiment, a case where recovery registration information and recovery collation information are represented by a common dimensional vector will be described as an example. Further, in the second example embodiment, biometric information may be extracted from a fingerprint, an iris, a retina, a face, a blood vessel (vein), a palm print, a voice print, or a combination thereof. The biometric information may be extracted from other information that can identify a living body other than the examples described above.

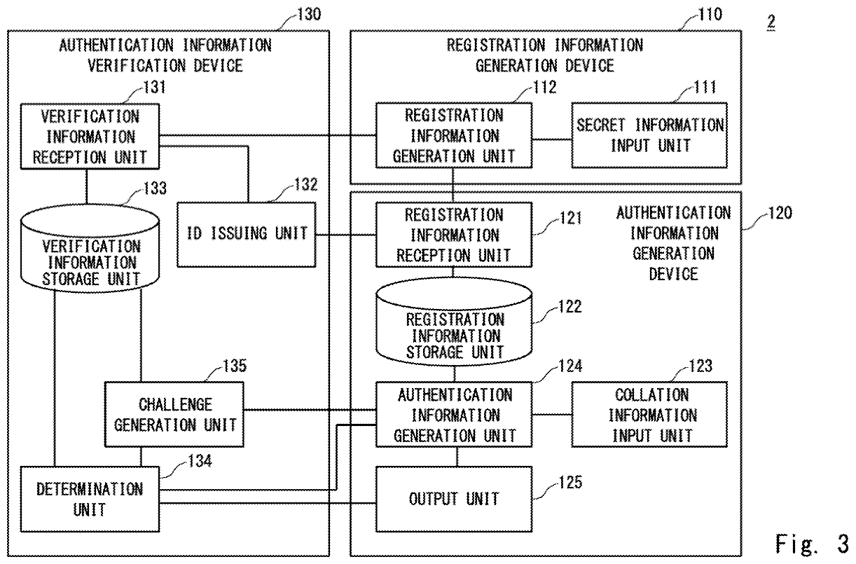

FIG. 3 is a schematic configuration diagram of the normal collation system 2 according to the second example embodiment. As described above, the normal collation system 2 includes the registration information generation device 110, the authentication information generation device 120, and the authentication information verification device 130.

### (Registration Information Generation Device 110)

The registration information generation device 110 includes a secret information input unit 111 and a registration information generation unit 112.

The secret information input unit 111 receives an input of secret information about a registrant.

The registration information generation unit 112 generates registration information and verification information from the secret information about the registrant being input to the secret information input unit 111. For example, the registration information may be information acquired by encrypting the secret information by using a secret key, and the verification information may be a public key (verification key) associated with a normal secret key. Further, for example, the registration information may be data about a nonce value of the secret information, and the verification information may be data about a hash value being calculated based on the secret information and the registration information.

Then, the registration information generation unit 112 transmits the registration information to a registration information reception unit 121 of the authentication information generation device 120 described below, and transmits the verification information to a verification information reception unit 131 of the authentication information verification device 130 described below.

The secret information input unit 111 and the registration information generation unit 112 are achieved by, for example, a CPU of a computer operating according to a client program or a server program, and a communication interface of the computer. For example, the CPU reads the client program or the server program from a program recording medium such as a program storage device of the computer. Then, the CPU may operate as the secret information input unit 111 and the registration information generation unit 112 by using the communication interface according to the program.

### (Authentication Information Generation Device 120)

The authentication information generation device 120 includes the registration information reception unit 121, a registration information storage unit 122, a collation information input unit 123, an authentication information generation unit 124, and an output unit 125.

The registration information reception unit 121 receives the registration information transmitted from the registration information generation device 110 and an ID transmitted from the authentication information verification device 130, and stores the registration information and the ID in the registration information storage unit 122.

The registration information storage unit 122 is a device that stores the registration information and the ID in association with each other.

The collation information input unit 123 receives an input of collation information from an authenticated subject.

The authentication information generation unit 124 calculates authentication information to be used in authentication from the registration information and the collation information. Note that a challenge-response method is introduced into the normal collation system 2 according to the second example embodiment in order to prevent an attacker who intercepts communication between the client-side system 20a and the server-side system 10a from spoofing the client. Therefore, the authentication information generation unit 124 calculates the authentication information as a response associated with a challenge signal. However, the challenge-response method may not be introduced into the normal collation system 2.

The output unit 125 receives authentication result information indicating a result of authentication being transmitted from the authentication information verification device 130. Further, the output unit 125 outputs the received authentication result information to the outside of the authentication information generation device 120.

The registration information reception unit 121, the collation information input unit 123, the authentication information generation unit 124, and the output unit 125 are achieved by, for example, a CPU of a computer operating according to a client program, and a communication interface of the computer. For example, the CPU reads the client program from a program recording medium such as a program storage device of the computer. Then, the CPU may operate as the registration information reception unit 121, the collation information input unit 123, the authentication information generation unit 124, and the output unit 125 by using the communication interface according to the program.

The registration information storage unit 122 is achieved by a storage device included in the computer, for example.

### (Authentication Information Verification Device 130)

The authentication information verification device 130 includes the verification information reception unit 131, an ID issuing unit 132, a verification information storage unit 133, a determination unit 134, and a challenge generation unit 135.

The verification information reception unit 131 receives the verification information being generated by the registration information generation device 110 and transmitted from the registration information generation device 110, and stores the verification information in the verification information storage unit 133.

The ID issuing unit 132 issues an identification number (ID) for each registrant, and stores the ID in the verification information storage unit 133.

The verification information storage unit 133 is a device that stores the verification information and the ID in association with each other.

The determination unit 134 determines whether the registrant and the authenticated subject coincide with each other from the authentication information received from the authentication information generation device 120 and the verification information stored in the verification information storage unit 133. When the registrant and the authenticated subject coincide with each other, the determination unit 134 transmits authentication result information indicating “accepted” to the authentication information generation device 120. When the registrant and the authenticated subject do not coincide with each other, the determination unit 134 transmits authentication result information indicating “rejected” to the authentication information generation device 120.

When the authentication information generation device 120 receives the authentication result information indicating “accepted”, the authentication information generation device 120 performs processing after authentication associated with the ID on an assumption that the authentication succeeds. However, a device that performs the processing after the authentication is not limited to the authentication information generation device 120, and a device other than the authentication information generation device 120 may perform the processing after the authentication being associated with the ID on a condition that the authentication result information indicating “accepted” is acquired.

The challenge generation unit 135 generates a challenge signal before the determination unit 134 receives the authentication information from the authentication information generation device 120, and transmits the generated challenge signal to the authentication information generation device 120. Note that the challenge-response may not be performed, and, in this case, the challenge generation unit 135 may not be provided in the authentication information verification device 130.

The verification information reception unit 131, the ID issuing unit 132, the determination unit 134, and the challenge generation unit 135 are achieved by, for example, a central processing unit (CPU) of a computer operating according to a server program, and a communication interface of the computer. For example, the CPU reads the server program from a program recording medium such as a program storage device of the computer. Then, the CPU may operate as the verification information reception unit 131, the ID issuing unit 132, the determination unit 134, and the challenge generation unit 135 by using the communication interface according to the program.

The verification information storage unit 133 is achieved by a storage device included in the computer, for example.

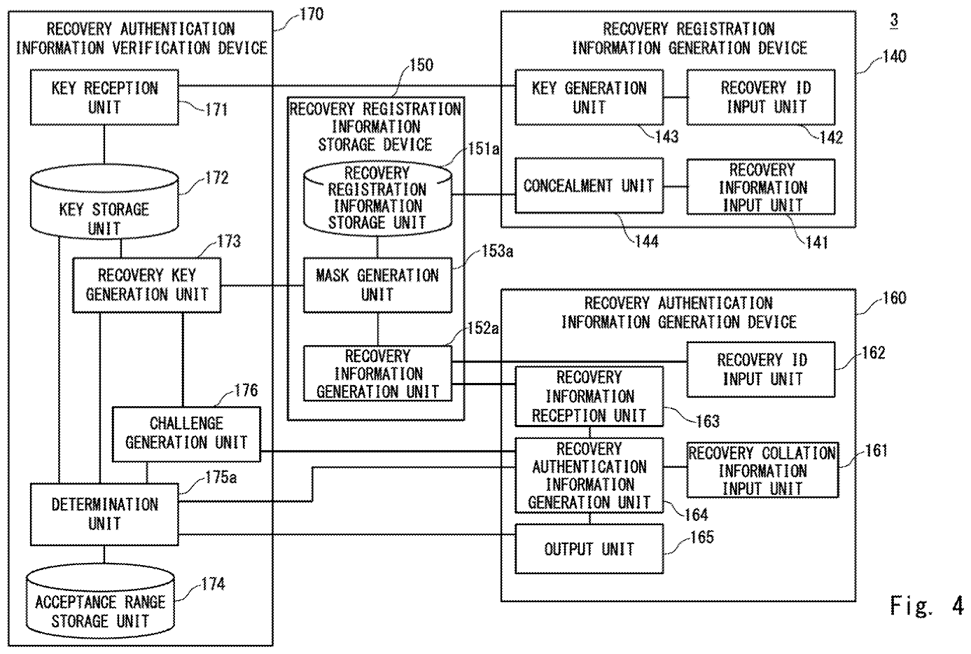

FIG. 4 is a schematic configuration diagram of the recovery collation system 3 according to the second example embodiment. As described above, the recovery collation system 3 includes the recovery registration information generation device 140, the recovery registration information storage device 150, the recovery authentication information generation device 160, and the recovery authentication information verification device 170.

### (Recovery Registration Information Generation Device 140)

The recovery registration information generation device 140 includes a recovery information input unit 141, a recovery ID input unit 142, a key generation unit 143, and a concealment unit 144.

The recovery information input unit 141 may be an input device according to recovery registration input information. The recovery information input unit 141 may be an input device that extracts a vector to be recovery registration input information from biometric information, and receives the vector as an input. Further, the recovery information input unit 141 may be an input device to which a vector to be recovery registration input information is directly input. Hereinafter, a vector corresponding to biometric information about a registrant being input to the recovery information input unit 141 is described as X.

The recovery ID input unit 142 acquires a recovery ID of a registrant.

The key generation unit 143 generates a secret key sk and a public key pk associated with the secret key sk. The key generation unit 143 transmits the public key pk and the recovery ID to a key reception unit 171 of the recovery authentication information verification device 170.

The concealment unit 144 generates recovery registration information by using the biometric information X and the secret key sk. In other words, the concealment unit 144 functions as a template generation means. Then, the concealment unit 144 transmits the recovery registration information and the recovery ID to a recovery registration information storage unit 151a of the recovery registration information storage device 150.

The recovery information input unit 141, the recovery ID input unit 142, the key generation unit 143, and the concealment unit 144 are achieved by, for example, a CPU of a computer operating according to a client program, and a communication interface of the computer. For example, the CPU reads the client program from a program recording medium such as a program storage device of the computer. Then, the CPU may operate as the recovery information input unit 141, the recovery ID input unit 142, the key generation unit 143, and the concealment unit 144 by using the communication interface according to the program.

### (Recovery Registration Information Storage Device 150)

The recovery registration information storage device 150 includes the recovery registration information storage unit 151a, a recovery information generation unit 152a, and a mask generation unit 153a.

The recovery registration information storage unit 150a receives the recovery registration information and the recovery ID from the recovery registration information generation device 140, and stores the recovery registration information and the recovery ID. In other words, the recovery registration information storage unit 151a is associated with the template storage unit 151 according to the first example embodiment.

The recovery information generation unit 152a receives the recovery ID from the recovery authentication information generation device 160, and acquires the recovery registration information associated with the recovery ID from the recovery registration information storage unit 151a. Then, the recovery information generation unit 152a generates recovery information from the recovery registration information and a random number mask R_M generated by the mask generation unit 153a, and transmits the recovery information to a recovery information reception unit 163 of the recovery authentication information generation device 160. In other words, the recovery information generation unit 152a is associated with the protected template generation unit 152 according to the first example embodiment.

The mask generation unit 153a generates the random number mask R_M. The mask generation unit 153a is associated with the random number generation unit 153 according to the first example embodiment.

The recovery registration information storage unit 151a, the recovery information generation unit 152a, and the mask generation unit 153a are achieved by, for example, a CPU of a computer operating according to a server program, and a communication interface of the computer. For example, the CPU reads the server program from a program recording medium such as a program storage device of the computer. Then, the CPU may operate as the recovery registration information storage unit 151a, the recovery information generation unit 152a, and the mask generation unit 153a by using the communication interface according to the program.

The recovery registration information storage unit 151a is achieved by a storage device included in the computer, for example.

### (Recovery Authentication Information Generation Device 160)

The recovery authentication information generation device 160 includes a recovery collation information input unit 161, a recovery ID input unit 162, the recovery information reception unit 163, a recovery authentication information generation unit 164, and an output unit 165.

The recovery collation information input unit 161 may be an input device according to recovery collation information. Further, the recovery collation information input unit 161 may be an input device to which a vector to be recovery collation information is directly input. A vector corresponding to biometric information about an authenticated subject being input to the recovery collation information input unit 161 is described as Y.

The recovery ID input unit 162 acquires the recovery ID, and transmits the recovery ID to the recovery information generation unit 152a of the recovery registration information storage device 150.

The recovery information reception unit 163 receives the recovery information from the recovery registration information storage device 150.

The recovery authentication information generation unit 164 generates, from the biometric information Y about the authenticated subject and the recovery information, data (hereinafter described as recovery authentication information) acquired by concealing an index indicating a degree of similarity between the biometric information X and the biometric information Y. The recovery authentication information may be determined based on an inner product of the recovery collation information and the recovery registration information. Note that the recovery information is a value in which the random number mask R_M is added to the recovery registration information acquired by concealing the biometric information X about the registrant. The recovery authentication information generation unit 164 generates the recovery authentication information without canceling concealment of the recovery information.

Herein, the challenge-response method is introduced into the recovery collation system 3 according to the second example embodiment in order to prevent an attacker who intercepts communication between the client-side system 20a and the server-side system 10a from spoofing the client. Specifically, the recovery authentication information verification device 170 transmits a challenge signal different each time for each authentication to the recovery authentication information generation device 160. Then, the recovery authentication information generation device 160 calculates a response being associated with the challenge signal and including a degree of similarity between the recovery information and the recovery collation information, and thus a value of the response is changed for each authentication. In this way, even when an attacker acquires a value of a response through interception, the intercepted value is unusable in next recovery authentication, and the attacker cannot generate a response associated with a different challenge, and thus a spoofed client is prevented.

Therefore, the recovery authentication information generation unit 164 generates the recovery authentication information as a response associated with a challenge signal, based on the challenge signal received from the recovery authentication information verification device 170 in addition to the biometric information Y and the recovery information.

The output unit 165 receives authentication result information indicating a result of biometric authentication being transmitted from the recovery authentication information verification device 170. Further, the output unit 165 outputs the received authentication result information to the outside of the recovery authentication information generation device 160.

The recovery information reception unit 163, the recovery authentication information generation unit 164, and the output unit 165 are achieved by, for example, a CPU of a computer operating according to a client program, and a communication interface of the computer. For example, the CPU reads the client program from a program recording medium such as a program storage device of the computer. Then, the CPU may operate as the recovery information reception unit 163, the recovery authentication information generation unit 164, and the output unit 165 by using the communication interface according to the program.

The recovery collation information input unit 161 is achieved by, for example, a CPU of a computer operating according to a client program, and an interface of the computer. For example, the CPU may read the client program from a program recording medium such as a program storage device of the computer, and operate as the recovery collation information input unit 161 by using the interface according to the program.

The recovery ID input unit 162 is achieved by, for example, a CPU of a computer operating according to a client program, and an interface and a communication interface of the computer. For example, the CPU reads the client program from a program recording medium such as a program storage device of the computer. Then, the CPU may operate as the recovery ID input unit 162 by using the interface and the communication interface according to the program.

### (Recovery Authentication Information Verification Device 170)

The recovery authentication information verification device 170 includes the key reception unit 171, a key storage unit 172, a recovery key generation unit 173, an acceptance range storage unit 174, a determination unit 175a, and a challenge generation unit 176.

The key reception unit 171 receives the public key pk and the recovery ID from the recovery registration information generation device 140.

The key storage unit 172 stores the public key pk and the recovery ID in association with each other.

The recovery key generation unit 173 generates a recovery verification key pk′ by using the public key pk associated with the recovery ID received from the recovery authentication information generation device 160 and the random number mask R_M received from the recovery registration information storage device 150.

The determination unit 175a determines whether the registrant and the authenticated subject coincide with each other by determining, by using the recovery verification key pk′, whether the recovery authentication information received from the recovery authentication information generation device 160 has a value within a predetermined acceptance range. Note that the predetermined acceptance range is stored in the acceptance range storage unit 174.

In other words, the determination unit 175a determines that the registrant and the authenticated subject coincide with each other when the recovery authentication information has a value within the acceptance range. Coincidence between the registrant and the authenticated subject corresponds to the recovery collation information and the recovery registration information being associated with each other. Further, the determination unit 175a determines that the registrant and the authenticated subject do not coincide with each other when the recovery authentication information does not have a value within the acceptance range. In other words, the determination unit 175a is associated with the determination unit 175 according to the first example embodiment.

When the registrant and the authenticated subject coincide with each other, the determination unit 175a transmits authentication result information indicating “accepted” to the recovery authentication information generation device 160. When the registrant and the authenticated subject do not coincide with each other, the determination unit 175a transmits authentication result information indicating “rejected” to the recovery authentication information generation device 160.

When the recovery authentication information generation device 160 receives the authentication result information indicating “accepted”, the recovery authentication information generation device 160 performs processing after authentication associated with the recovery ID on an assumption that the authentication succeeds. However, a device that performs the processing after the authentication is not limited to the recovery authentication information generation device 160, and a device other than the recovery authentication information generation device 160 may perform the processing after the authentication being associated with the recovery ID on a condition that the authentication result information indicating “accepted” is acquired.

The challenge generation unit 176 generates a challenge signal for each authentication, i.e., each piece of the recovery collation information. The challenge generation unit 176 transmits the generated challenge signal to the recovery authentication information generation device 160 before the determination unit 175a receives the recovery authentication information from the recovery authentication information generation device 160.

The key reception unit 171, the recovery key generation unit 173, the determination unit 175a, and the challenge generation unit 176 are achieved by, for example, a CPU of a computer operating according to a server program, and a communication interface of the computer. For example, the CPU reads the server program from a program recording medium such as a program storage device of the computer. Then, the CPU may operate as the key reception unit 171, the recovery key generation unit 173, the determination unit 175a, and the challenge generation unit 176 by using the communication interface according to the program.

The key storage unit 172 and the acceptance range storage unit 174 are achieved by a storage device included in the computer, for example.

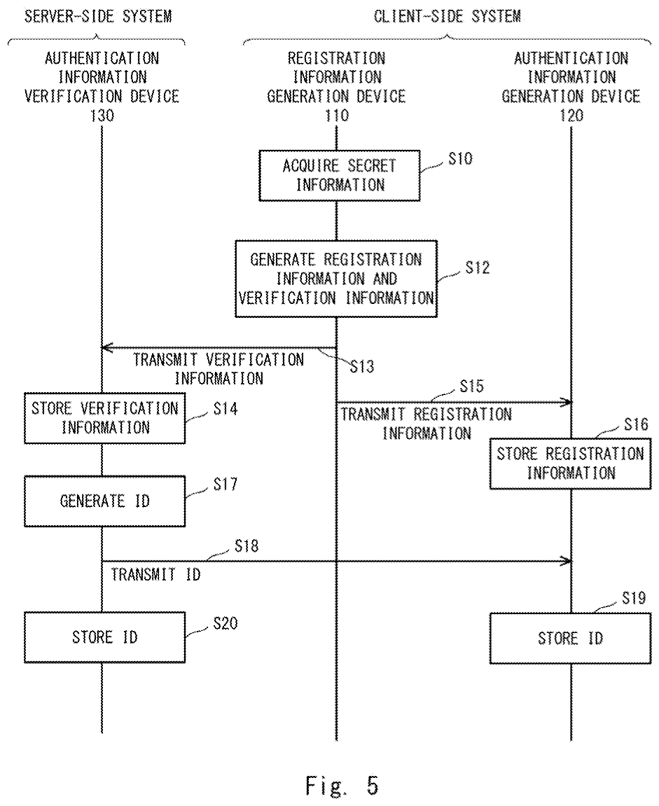

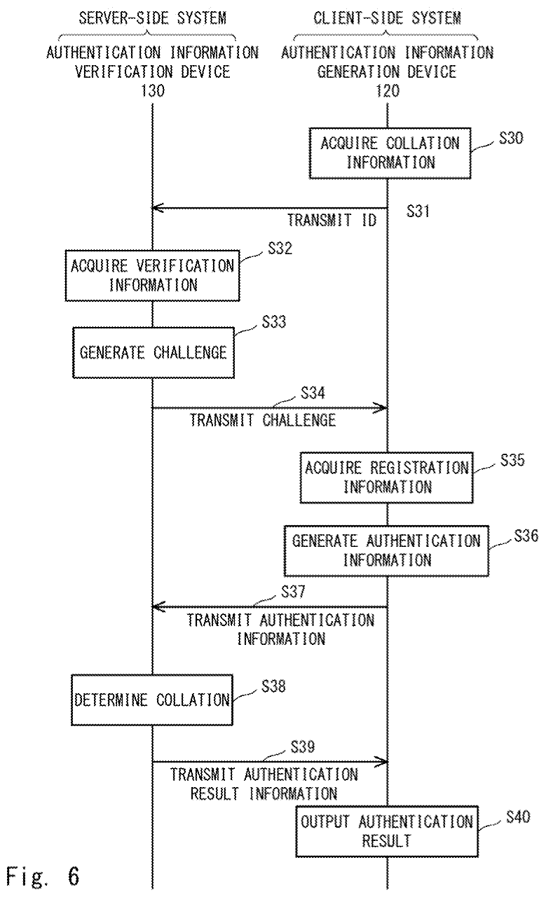

Next, processing of the normal collation system 2 will be described by using FIGS. 5 to 6.

FIG. 5 is a sequence diagram illustrating a procedure of registration processing of the normal collation system 2 according to the second example embodiment. Note that a detailed description of a manner that has already been described will be omitted.

First, the secret information input unit 111 of the registration information generation device 110 receives an input of secret information about a registrant, and acquires the secret information (step S10). Next, the registration information generation unit 112 of the registration information generation device 110 generates registration information and verification information from the secret information (step S12). Next, the registration information generation unit 112 of the registration information generation device 110 transmits the verification information to the authentication information verification device 130 (step S13).

The verification information reception unit 131 of the authentication information verification device 130 stores the verification information in the verification information storage unit 133 in response to reception of the verification information (step S14).

Further, the registration information generation unit 112 of the registration information generation device 110 transmits the registration information to the registration information reception unit 121 of the authentication information generation device 120 (step S16).

The registration information reception unit 121 of the authentication information generation device 120 stores the registration information in the registration information storage unit 122 in response to reception of the registration information (step S16).

Next, the ID issuing unit 132 of the authentication information verification device 130 issues an ID (step S17). Then, the ID issuing unit 132 transmits the ID to the registration information reception unit 121 of the authentication information generation device 120 (step S18).

Next, the registration information reception unit 121 of the authentication information generation device 120 stores the ID in association with the registration information in the registration information storage unit 122 in response to reception of the ID (step S19).

Further, the verification information storage unit 133 of the authentication information verification device 130 stores the ID and the registration information in association with each other (step S20).

FIG. 6 is a sequence diagram illustrating a procedure of authentication processing of the normal collation system 2 according to the second example embodiment.

First, the collation information input unit 123 of the authentication information generation device 120 receives an input of collation information about an authenticated subject, and acquires the collation information (step S30). Next, the authentication information generation device 120 transmits an ID stored in the registration information storage unit 122 to the determination unit 134 of the authentication information verification device 130 (step S31).

The determination unit 134 of the authentication information verification device 130 acquires verification information associated with the ID from the verification information storage unit 133 in response to reception of the ID (step S32). Next, the challenge generation unit 135 of the authentication information verification device 130 generates a challenge (step S33). Next, the challenge generation unit 135 transmits the challenge to the authentication information generation device 120 (step S34).

The authentication information generation unit 124 of the authentication information generation device 120 that has received the challenge acquires registration information from the registration information storage unit 122 (step S35). Next, the authentication information generation unit 124 generates authentication information as a response (step S36). Next, the authentication information generation unit 124 transmits the authentication information to the authentication information verification device 130 (step S37).

The determination unit 134 of the authentication information verification device 130 performs a collation determination from the authentication information and the verification information in response to reception of the authentication information (step S38). Next, the determination unit 134 transmits authentication result information indicating a collation result to the authentication information generation device 120 (step S39).

The output unit 125 of the authentication information generation device 120 outputs an authentication result in response to reception of the authentication result information (step S40).

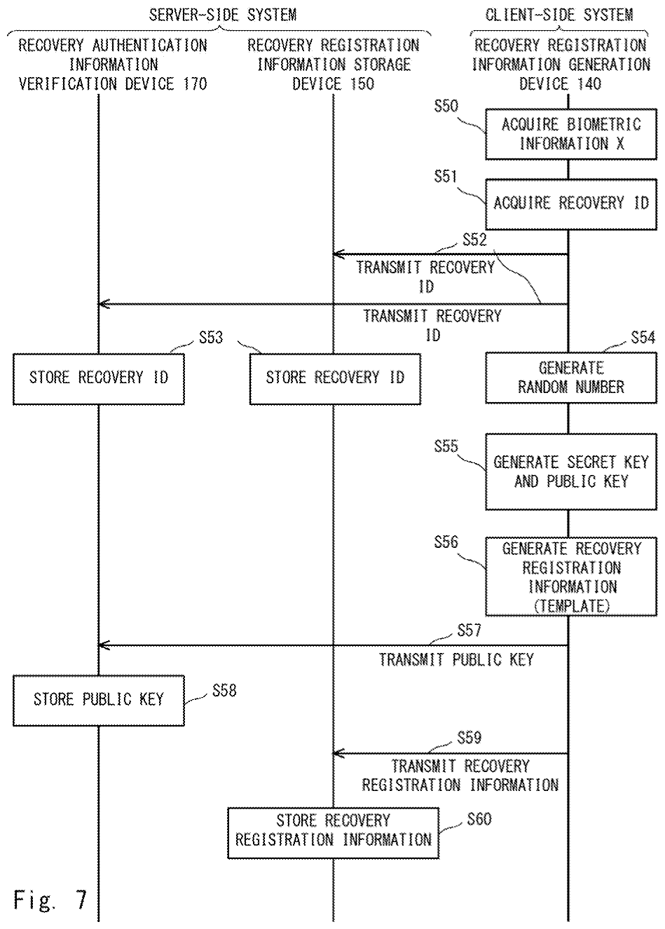

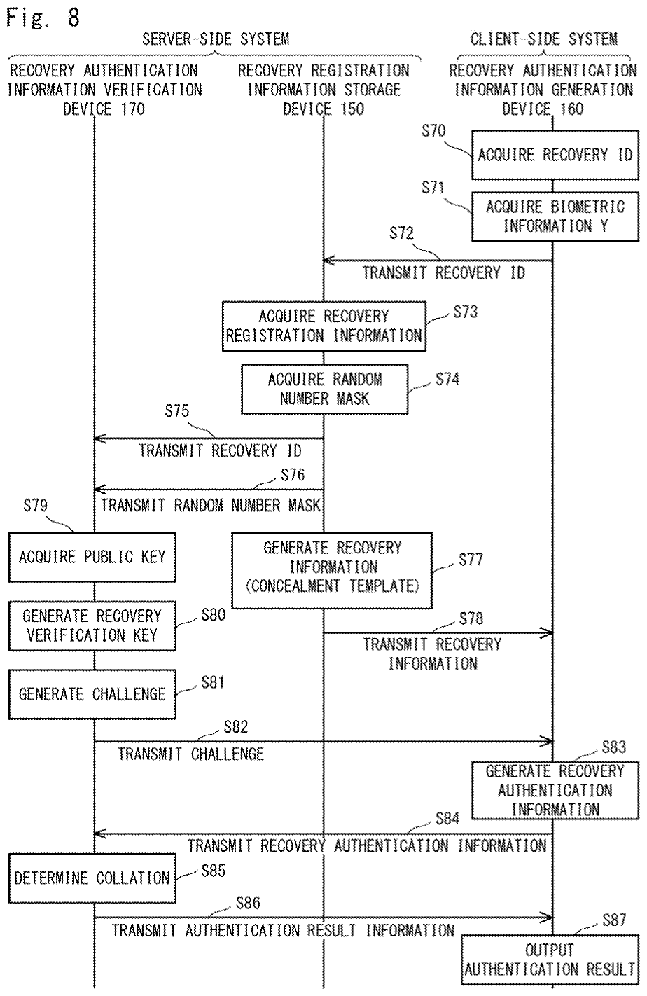

Next, processing of the recovery collation system 3 will be described by using FIGS. 7 to 8.

FIG. 7 is a sequence diagram illustrating a procedure of the recovery registration processing of the recovery collation system 3 according to the second example embodiment.

First, the recovery information input unit 141 of the recovery registration information generation device 140 receives an input of biometric information X about a registrant by the registrant, and acquires the biometric information X (step S50). Next, the recovery ID input unit 142 of the recovery registration information generation device 140 receives an input of a recovery ID by the registrant, and acquires the recovery ID (step S51). The recovery registration information generation device 140 transmits the recovery ID to the recovery registration information storage unit 151a of the recovery registration information storage device 150 and the key reception unit 171 of the recovery authentication information verification device 170 (step S52).

The recovery registration information storage device 150 and the recovery authentication information verification device 170 store the recovery ID in the recovery registration information storage unit 151a and the key storage unit 172, respectively, in response to reception of the recovery ID (step S53).

Meanwhile, the key generation unit 143 of the recovery registration information generation device 140 generates a random number (step S54). Then, the key generation unit 143 generates a secret key sk and a public key pk, based on the random number (step S55). Next, the concealment unit 144 of the recovery registration information generation device 140 generates recovery registration information from the biometric information X and the secret key sk (step S56). The recovery registration information is also referred to as a template. The key generation unit 143 transmits the public key pk to the key reception unit 171 of the recovery authentication information verification device 170 (step S57).

The key reception unit 171 of the recovery authentication information verification device 170 stores the public key pk in the key storage unit 172 in response to reception of the public key pk (step S58).

Meanwhile, the concealment unit 144 of the recovery registration information generation device 140 transmits the recovery registration information to the recovery registration information storage device 150 (step S59).

The recovery registration information storage device 150 stores the recovery registration information in the recovery registration information storage unit 151a in response to reception of the recovery registration information (step S60).

FIG. 8 is a sequence diagram illustrating a procedure of the recovery authentication processing of the recovery collation system 3 according to the second example embodiment.

First, the recovery ID input unit 162 of the recovery authentication information generation device 160 receives an input of a recovery ID by an authenticated subject, and acquires the recovery ID (step S70). Next, the recovery collation information input unit 161 of the recovery authentication information generation device 160 receives an input of biometric information Y about the authenticated subject by the authenticated subject, and acquires the biometric information Y (step S71). Next, the recovery ID input unit 162 transmits the recovery ID to the recovery registration information storage device 150 (step S72).

The recovery information generation unit 152a of the recovery registration information storage device 150 acquires recovery registration information associated with the recovery ID from the recovery registration information storage unit 151a in response to reception of the recovery ID (step S73). Next, the mask generation unit 153a of the recovery registration information storage device 150 generates a random number mask (step S74). The mask generation unit 153a transmits the recovery ID and the random number mask to the recovery authentication information verification device 170 (steps S75, 76). In this way, the recovery key generation unit 173 of the recovery authentication information verification device 170 receives the recovery ID and the random number mask.

Next, the recovery information generation unit 152a of the recovery registration information storage device 150 generates recovery information from the recovery registration information and the random number mask (step S77). The recovery information is also referred to as a protected template. The recovery information generation unit 152a transmits the recovery information to the recovery authentication information generation device 160 (step S78). In this way, the recovery information reception unit 163 of the recovery authentication information generation device 160 receives the recovery information.

Next, the recovery key generation unit 173 of the recovery authentication information verification device 170 acquires a public key pk associated with the recovery ID from the key storage unit 172 (step S79). Next, the recovery key generation unit 173 generates a recovery verification key pk′ by using the public key pk and a random number mask R_M (step S80). Next, the challenge generation unit 176 of the recovery authentication information verification device 170 generates a challenge (step S81), and transmits the challenge to the recovery authentication information generation unit 164 of the recovery authentication information generation device 160 (step S82).

The recovery authentication information generation unit 164 of the recovery authentication information generation device 160 generates recovery authentication information from the biometric information Y, the recovery information, and the challenge in response to reception of the challenge (step S83). Next, the recovery authentication information generation unit 164 transmits the recovery authentication information to the determination unit 175a of the recovery authentication information verification device 170 (step S84).

The determination unit 175a of the recovery authentication information verification device 170 performs, by using the recovery verification key pk′ and the challenge, collation whether there is an index included in an acceptance range in the recovery authentication information in response to reception of the recovery authentication information (step S85). Further, the determination unit 175a transmits authentication result information indicating a collation result to the output unit 165 of the recovery authentication information generation device 160 (step S86).

Next, the output unit 165 of the recovery authentication information generation device 160 outputs an authentication result in response to reception of the authentication result information (step S87). Subsequently, when the authentication (collation) succeeds, processing of recovering registration information is performed.

Hereinafter, a specific example of the processing of the recovery collation system 3 according to the second example embodiment will be described. In the following description, it is assumed that the biometric information X and the biometric information Y are both an n-dimensional vector. Then, it is assumed that each element of X is represented by X=(x_1, x_2, . . . , x_n), and each element of Y is represented by Y=(y_1, y_2, . . . , y_n). Further, it is assumed that a symbol i represents 1, 2, . . . , n. For example, {u_i}=u_1, u_2, . . . , u_n.

### (Specific Example)

In the present specific example, specific recovery registration processing and recovery authentication processing when a Schnorr signature is used will be described. In the present specific example, a case where an index indicating similarity between the biometric information X and the biometric information Y is an inner product of the biometric information X and the biometric information Y is considered. An inner product <X, Y> of the biometric information X and the biometric information Y is Σ(x_i·y_i). Hereinafter, one example of processing when an index is an inner product is exemplified.

Further, in the present specific example, the Schnorr signature is used. In the Schnorr signature, a set of the secret key sk and the public key pk=g\hat{ }sk is generated. Note that skϵZ_q (Z_q={0, 1, . . . , q−1}, q is a prime) is used (Z is a symbol for a group of the whole integers). Further, g is a generation source of a group G of an order q. In other words, G={g_0, g_1, . . . , g_q−1}. Z_q, g, and G are shared among all devices.

Furthermore, an acceptance range Θ={θ_1, . . . , θ_m} is provided to the recovery authentication information verification device 170. The acceptance range storage unit 174 of the recovery authentication information verification device 170 stores Θ′={g\hat{ }(θ_1), . . . , g\hat{ }(θ_m)}. Note that Θ′ is a group of power of g in which each value of Θ is an exponent.

Note that it is assumed that general authentication such as ID/password authentication is performed in the registration processing and the authentication processing by the normal collation system 2 in the present specific example, and description will be omitted.

Hereinafter, specific recovery registration processing by the recovery collation system 3 when the Schnorr signature is used will be described.

First, the biometric information X about a registrant is input to the recovery information input unit 141. Next, a recovery ID is input to the recovery ID input unit 142. Next, the key generation unit 143 generates a random number as in equations (1) to (4) below.

R_1<−\hat{ }RZ_q (1)

R_2<−\hat{ }RZ_q (2)

R_3<−\hat{ }RZ_q (3)

(r_1,r_2, . . . ,r_n)<−\hat{ }RZ_q (4)

The key generation unit 143 regards R_3 as a secret key, and generates a public key g\hat{ }(R_3), based on the secret key. Further, the key generation unit 143 regards {r_i} and random numbers R_1 and R_2 as concealment keys. The concealment keys are unique keys being unique for each registrant, i.e., each piece of the biometric information X.

The key generation unit 143 inputs the secret key R_3 and the concealment keys {r_i}, R_1, and R_2 to the concealment unit 144. Further, the key generation unit 143 transmits the recovery ID, the public key g\hat{ }(R_3), and the concealment keys R_1 and R_2 to the key reception unit 171 of the recovery authentication information verification device 170.

Next, the key storage unit 172 stores, in association with one another, the recovery ID, the public key, and the concealment keys R_1 and R_2 that are received.

Next, the concealment unit 144 of the recovery registration information generation device 140 generates R_1·x_i+R_2·r_i+R_3 and g\hat{ }(r_i) with respect to i=1, 2, . . . , n, based on the input secret key, the input concealment keys, and the biometric information X. Hereinafter, templates are assumed to be {R_1·x_i+R_2·r_i+R3} and {g\hat{ }(r_i)}.

The concealment unit 144 transmits the recovery ID and the templates to the recovery registration information storage unit 151a of the recovery registration information storage device 150. Then, the recovery registration information storage unit 151a stores the recovery ID and the templates, and ends the recovery registration processing.

Note that the recovery registration information storage device 150 that holds a template does not hold a concealment key and a public key in order to reduce a security risk.

Next, specific recovery authentication processing by the recovery collation system 3 when the Schnorr signature is used will be described.

First, the recovery authentication information generation device 160 transmits a recovery ID to the recovery registration information storage device 150.

Next, the recovery information generation unit 152a acquires a template associated with the recovery ID from the recovery registration information storage unit 151a.

Herein, the recovery information generation unit 152a transmits {g\hat{ }r_i} to the recovery authentication information verification device 170 in order to conceal {g\hat{ }r_i}.

Next, the recovery authentication information verification device 170 generates a random number as in an equation (5) below.

(r′_1,r′_2, . . . ,r′_n)<−\hat{ }RZ_q (5)

Next, the recovery authentication information verification device 170 calculates {g\hat{ }(r_i+r′_i)} and {r′_i·R_2}, and transmits {g\hat{ }(r_i+r′_i)} and {r′_i·R_2} to the recovery registration information storage device 150.

Next, the recovery information generation unit 152a of the recovery registration information storage device 150 receives {g\hat{ }(r_i+r′_i)} and {r′ _iR_}.

Next, the mask generation unit 153a generates a random number as in equations (6) to (8) below.

R′_1<−\hat{ }RZ_q (6)

R′_2<−\hat{ }RZ_q (7)

R′_3<−\hat{ }RZ_q (8)

Next, the recovery information generation unit 152a generates, as recovery information, {R′_1·R_1·x_i+R′_1·R_2·(r_i+r′i)+R′_1·R_3+R′_3} and {g\hat{ }(r_i+r′_i)·(1/R′_2)}.

Next, the mask generation unit 153a transmits masks R′_1, R′_2, and R′_3 to the recovery key generation unit 173 of the recovery authentication information verification device 170. In this way, the recovery key generation unit 173 receives the masks R′_1, R′_2, and R′_3.

Next, the recovery information generation unit 152a of the recovery registration information storage device 150 transmits the recovery information to the recovery information reception unit 163 of the recovery authentication information generation device 160. In this way, the recovery information reception unit 163 of the recovery authentication information generation device 160 receives the recovery information.

Next, the biometric information Y about an authenticated subject is input to the recovery collation information input unit 161. The recovery authentication information generation unit 164 acquires the biometric information Y from the recovery collation information input unit 161.

Next, the recovery authentication information generation unit 164 calculates σ_1=g\hat{ }(Σ(r_i+r′_i)·y_i)·(1/R′_2). Subsequently, the recovery authentication information generation unit 164 transmits the recovery ID and σ_1 to the determination unit 175a of the recovery authentication information verification device 170.

Next, the recovery authentication information verification device 170 that has received the recovery ID and σ_1 generates M,R<−\hat{ }RZ_q in the challenge generation unit 176. Then, the recovery authentication information verification device 170 calculates g\hat{ }(R·(R′_1·R_3+R′_3)) by using the public key g\hat{ }(R_3) and the masks R′_1 and R′_3 stored in the key storage unit 172. Subsequently, M,g\hat{ }(R·(R′_1·R_3+R′_3)) is transmitted as a challenge to the recovery authentication information generation unit 164 of the recovery authentication information generation device 160.

Next, the recovery authentication information generation unit 164 calculates S=H(M,g\hat{ }r). Note that H is a cryptographic hash function. Next, the recovery authentication information generation unit 164 calculates each value below from equations (9) to (11), based on the input biometric information Y and the input template.

A=Σ_i(R′_1·R_1·x_i+R′_1·R_2·(r_i+r′i)+R′_1·R3+R′_3)·y_i (9)

σ_2=r−A·S (10)

σ_3=g\hat{ }(R·(R′_1·R_3+·R′_3)·y_i) (11)

After each value is calculated, the recovery authentication information generation unit 164 transmits, to the determination unit 175a of the recovery authentication information verification device 170, (S, σ_2, σ_3) as a response including the inner product of the biometric information X and the biometric information Y. (S_j, σ_2, σ_3) corresponds to the Schnorr signature having A as a secret key.

The determination unit 175a receives the response from the recovery authentication information generation unit 164. The determination unit 175a verifies digital signatures S, σ_2, and σ_3 by using the public key g\hat{ }(R_3) stored together with the recovery ID in the key storage unit 172, and the concealment keys R_1 and R_2 and the masks R′_1 and R′_2. Specifically, an equation (12) below is calculated.

v=[{g\hat{ }(σ_2)}·{(σ_3)\hat{ }(S·R)}·{(σ_1)\hat{ }(S·R′_1·R_2·R′_2)}·(g\hat{ }(−r))]\hat{ }(−1/R_1·R′_1) (12)

The determination unit 175a confirms whether calculated v is included in Θ′. When v is not included in Θ′, the determination unit 175a generates authentication result information indicating that “authentication fails”. Further, when v is included in Θ′, the determination unit 175a generates authentication result information indicating that “authentication succeeds”.

Next, the determination unit 175a transmits the generated authentication result information to the output unit 165 of the recovery authentication information generation device 160. Next, the output unit 165 that has received the authentication result information outputs the authentication result information. When the authentication succeeds, access authority to an ID of an authenticated subject is recovered, and the authenticated subject performs normal registration processing.

Note that, in the present specific example, the Schnorr signature is used in the present specific example, but another digital signature method that is safe in terms of cryptography, such as a DSA signature, may be used.

In this way, in the present specific example, the key storage unit 172 of the recovery authentication information verification device 170 stores a concealment key and a public key being unique for each piece of the biometric information X. Then, the mask generation unit 153a of the recovery registration information storage device 150 functions as a first random number generation means for generating a first random number in response to a request from a client. Further, the recovery authentication information verification device 170 functions as a second random number generation means for generating a second random number in response to a request from the client, and generates a key (concealment unique key) acquired by further concealing a concealment key by using the second random number. The recovery information generation unit 152a of the recovery registration information storage device 150 generates recovery information acquired by concealing a template by using the first random number and the concealment unique key. Then, the determination unit 175a of the recovery authentication information verification device 170 decrypts a concealment index included in a response by using the public key, the first random number, and the unique key as recovery verification keys.

By adopting such a configuration, a storage place of a concealment key and a storage place of a template can be separately managed. Therefore, a security risk is reduced.

In the present second example embodiment and the specific example thereof, the collation system 1 uses, for an account recovery, biometric authentication that can perform collation while protecting a template. The biometric authentication in the present second example embodiment has a higher level of convenience than a method for performing identification by an identification card, and a higher level of safety than a method for performing identification by a recovery code. Thus, the collation system 1 is a system having a small management cost of the server-side system 10a and a small leakage risk of biometric information, including a time of an account recovery.

Note that the collation system 1 may perform only the recovery registration processing and the recovery authentication processing. For example, the recovery registration information generation device 140, the recovery registration information storage device 150, the recovery authentication information generation device 160, and the recovery authentication information verification device 170 may constitute the collation system 1.

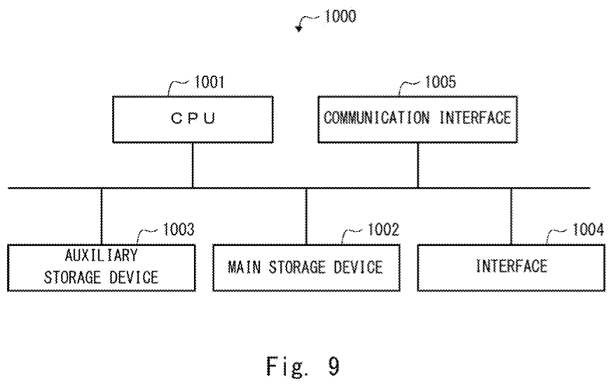

FIG. 9 is a schematic block diagram illustrating a configuration example of a computer according to a client and a server in the example embodiments described above and the specific examples thereof. Hereinafter, the description is given with reference to FIG. 9, and a computer used as a client and a computer used as a server are different computers.

A computer 1000 includes a CPU 1001, a main storage device 1002, an auxiliary storage device 1003, an interface 1004, and a communication interface 1005.

An operation of the computer 1000 that achieves a client is stored in the auxiliary storage device 1003 in a form of a client program. The CPU 1001 reads the client program from the auxiliary storage device 1003, develops the client program in the main storage device 1002, and performs the operation of the client described in the example embodiments and the specific examples thereof described above according to the client program.

An operation of the computer 1000 that achieves a server is stored in the auxiliary storage device 1003 in a form of a server program. The CPU 1001 reads the server program from the auxiliary storage device 1003, develops the server program in the main storage device 1002, and performs the operation of the server described in the example embodiments and the specific examples thereof described above according to the server program.

The auxiliary storage device 1003 is an example of a non-transitory tangible medium. Other examples of the non-transitory tangible medium include a magnetic disk connected via the interface 1004, a magneto-optical disk, a compact disk read only memory (CD-ROM), a digital versatile disk read only memory (DVD-ROM), a semiconductor memory, and the like. Further, when a program is distributed to the computer 1000 through a communication line, the computer 1000 that receives the distribution may develop the program in the main storage device 1002 and operate according to the program.

Further, a part or the whole of each of the components of the client may be achieved by general-purpose or dedicated circuitry, a processor, and the like, or achieved by a combination thereof. A part or the whole of each of the components may be formed by a single chip or formed by a plurality of chips connected to one another via a bus. A part or the whole of each of the components may be achieved by a combination of the above-described circuitry and the like and a program. This point is also similar to the server.

A part or the whole of the example embodiments described above can be described as, but not limited to, the following supplementary notes.

### (Supplementary Note 1)

A recovery verification system comprising:
template storage means for storing a template acquired by encrypting registration input information being biometric information about a registrant by using a secret key;
random number generation means for generating a random number in response to a request from a client;
protected template generation means for generating a protected template acquired by concealing the template by using the random number, and transmitting the protected template to the client; and
determination means,
wherein the determination means
   acquires, from the client, information about a concealment index that is an index acquired by concealing a degree of similarity between registration input information and collation information being biometric information about an authenticated subject and is calculated based on the collation information and the protected template, and
   generates an index acquired by decrypting the concealment index by using a public key associated with the secret key and the random number and performs authentication on the collation information, based on whether the generated index indicates a value within a predetermined range.

### (Supplementary Note 2)

The recovery verification system according to Supplementary Note 1, wherein the determination means accepts authentication of the collation information when the generated index indicates a value within a predetermined range.

### (Supplementary Note 3)

The recovery verification system according to Supplementary Note 1 or 2, further comprising challenge generation means for generating a challenge signal for each of pieces of the collation information, and transmitting the challenge signal to the client,
wherein, in the client, the concealment index is configured to be calculated as a response associated with the challenge signal.

### (Supplementary Note 4)

The recovery verification system according to any one of Supplementary Notes 1 to 3, wherein the registration input information and the collation information are both represented by a vector.

### (Supplementary Note 5)

The recovery verification system according to any one of Supplementary Notes 1 to 4, wherein the concealment index is determined based on an inner product of the collation information and the protected template.

### (Supplementary Note 6)

The recovery verification system according to any one of Supplementary Notes 1 to 5, further comprising key storage means for storing a unique key being unique for each of pieces of registration input information, wherein
the random number generation means includes
   first random number generation means for generating a first random number in response to the request from the client, and
   second random number generation means for generating a second random number in response to the request from the client,
the protected template generation means generates the protected template by using the first random number and a concealment unique key acquired by concealing the unique key by using the second random number, and
the determination means generates an index acquired by decrypting the concealment index by using the public key, the first random number, and the unique key.

### (Supplementary Note 7)

A collation system comprising:
a client;
a normal verification system configured to perform authentication on normal collation information being input for collation with normal registration input information about a registrant; and
a recovery verification system configured to recover an account related to the normal registration input information about the registrant, wherein
the recovery verification system includes
   template storage means for storing a template acquired by encrypting recovery registration input information being biometric information about the registrant by using a secret key;
   random number generation means for generating a random number in response to a request from the client;
   protected template generation means for generating a protected template acquired by concealing the template by using the random number, and transmitting the protected template to the client; and
   determination means, and
the determination means
   acquires, from the client, information about a concealment index that is an index acquired by concealing a degree of similarity between recovery registration input information and recovery collation information being biometric information about an authenticated subject and is calculated based on the recovery collation information and the protected template, and
   generates an index acquired by decrypting the concealment index by using a public key associated with the secret key and the random number and performs authentication on the recovery collation information, based on whether the generated index indicates a value within a predetermined range.

### (Supplementary Note 8)

The collation system according to Supplementary Note 7, wherein
the client includes
   key generation means for generating the secret key and the public key, and
   template generation means for generating the template by using the secret key, and
the key generation means transmits the public key to the recovery verification system.

### (Supplementary Note 9)

A recovery verification method comprising:
a random number generation stage of generating a random number in response to a request from a client;
a protected template generation stage of generating a protected template acquired by concealing a template by using the random number, and transmitting the protected template to the client, the template being acquired by encrypting registration input information being biometric information about a registrant by using a secret key;
an acquisition stage of acquiring, from the client, information about a concealment index that is an index acquired by concealing a degree of similarity between registration input information and collation information being biometric information about an authenticated subject and is calculated based on the collation information and the protected template; and
an authentication stage of generating an index acquired by decrypting the concealment index by using a public key associated with the secret key and the random number, and performing authentication on the collation information, based on whether the generated index indicates a value within a predetermined range.

### (Supplementary Note 10)

A non-transitory computer-readable medium storing a program causing a computer to execute:
random number generation processing of generating a random number in response to a request from a client;
protected template generation processing of generating a protected template acquired by concealing a template by using the random number, and transmitting the protected template to the client, the template being acquired by encrypting registration input information being biometric information about a registrant by using a secret key;
acquisition processing of acquiring, from the client, information about a concealment index that is an index acquired by concealing a degree of similarity between registration input information and collation information being biometric information about an authenticated subject and is calculated based on the collation information and the protected template; and
authentication processing of generating an index acquired by decrypting the concealment index by using a public key associated with the secret key and the random number, and performing authentication on the collation information, based on whether the generated index indicates a value within a predetermined range.

Although the present disclosure has been described with reference to the example embodiments, the present disclosure is not limited to the above-described example embodiments. Various modifications that can be understood by those skilled in the art can be made to the configuration and the details of the present disclosure within the scope of the invention.

### INDUSTRIAL APPLICABILITY

The present disclosure is suitably applied to a collation system for performing biometric authentication using a client and a server.

### REFERENCE SIGNS LIST

1 COLLATION SYSTEM
2 NORMAL COLLATION SYSTEM
3 RECOVERY COLLATION SYSTEM
10 RECOVERY VERIFICATION SYSTEM
10a SERVER-SIDE SYSTEM
20 CLIENT
20a CLIENT-SIDE SYSTEM
110 REGISTRATION INFORMATION GENERATION DEVICE
111 SECRET INFORMATION INPUT UNIT
112 REGISTRATION INFORMATION GENERATION UNIT
120 AUTHENTICATION INFORMATION GENERATION DEVICE
121 REGISTRATION INFORMATION RECEPTION UNIT
122 REGISTRATION INFORMATION STORAGE UNIT
123 COLLATION INFORMATION INPUT UNIT
124 AUTHENTICATION INFORMATION GENERATION UNIT
125, 165 OUTPUT UNIT
130 AUTHENTICATION INFORMATION VERIFICATION DEVICE
131 VERIFICATION INFORMATION RECEPTION UNIT
132 ID ISSUING UNIT
133 VERIFICATION INFORMATION STORAGE UNIT
134, 175, 175a DETERMINATION UNIT
135, 176 CHALLENGE GENERATION UNIT
174 ACCEPTANCE RANGE STORAGE UNIT
140 RECOVERY REGISTRATION INFORMATION GENERATION DEVICE
141 RECOVERY INFORMATION INPUT UNIT
142 RECOVERY ID INPUT UNIT
143 KEY GENERATION UNIT
144 CONCEALMENT UNIT
150 RECOVERY REGISTRATION INFORMATION STORAGE DEVICE
151 TEMPLATE STORAGE UNIT
151a RECOVERY REGISTRATION INFORMATION STORAGE UNIT
153 RANDOM NUMBER GENERATION UNIT
153a MASK GENERATION UNIT
152 PROTECTED TEMPLATE GENERATION UNIT
152a RECOVERY INFORMATION GENERATION UNIT
160 RECOVERY AUTHENTICATION INFORMATION GENERATION DEVICE
161 RECOVERY COLLATION INFORMATION INPUT UNIT
162 RECOVERY ID INPUT UNIT
163 RECOVERY INFORMATION RECEPTION UNIT
164 RECOVERY AUTHENTICATION INFORMATION GENERATION UNIT
170 RECOVERY AUTHENTICATION INFORMATION VERIFICATION DEVICE
171 KEY RECEPTION UNIT
172 KEY STORAGE UNIT
173 RECOVERY KEY GENERATION UNIT
1000 COMPUTER
1001 CPU
1002 MAIN STORAGE DEVICE
1003 AUXILIARY STORAGE DEVICE
1004 INTERFACE
1005 COMMUNICATION INTERFACE

What is claimed is:

1. A recovery verification system comprising:
at least one storage device configured to store instructions; and
at least one processor configured to execute the instructions to:
store a template acquired by encrypting registration input information being biometric information about a registrant by using a secret key;
generate a random number in response to a request from a client;
generate a protected template acquired by concealing the template by using the random number, and transmit the protected template to the client;
acquire, from the client, information about a concealment index that is an index acquired by concealing a degree of similarity between registration input information and collation information being biometric information about an authenticated subject and is calculated based on the collation information and the protected template; and
generate an index acquired by decrypting the concealment index by using a public key associated with the secret key and the random number and perform authentication on the collation information, based on whether the generated index indicates a value within a predetermined range.

2. The recovery verification system according to claim 1, wherein the at least one processor is further configured to execute the instructions to accept authentication of the collation information when the generated index indicates a value within a predetermined range.

3. The recovery verification system according to claim 1, wherein the at least one processor is further configured to execute the instructions to generate a challenge signal for each of pieces of the collation information, and transmitting the challenge signal to the client,
wherein, in the client, the concealment index is configured to be calculated as a response associated with the challenge signal.

4. The recovery verification system according to claim 1, wherein the registration input information and the collation information are both represented by a vector.

5. The recovery verification system according to claim 1, wherein the concealment index is determined based on an inner product of the collation information and the protected template.

6. The recovery verification system according to claim 1, wherein the at least one processor is further configured to execute the instructions to:
store a unique key being unique for each of pieces of registration input information;
generate a first random number in response to the request from the client;
generate a second random number in response to the request from the client;
generate the protected template by using the first random number and a concealment unique key acquired by concealing the unique key by using the second random number; and
generate an index acquired by decrypting the concealment index by using the public key, the first random number, and the unique key.

7. A collation system comprising:
a client;
a normal verification system configured to perform authentication on normal collation information being input for collation with normal registration input information about a registrant; and
a recovery verification system configured to recover an account related to the normal registration input information about the registrant, wherein
the recovery verification system includes:
at least one storage device configured to store instructions; and
at least one processor configured to execute the instructions to:
store a template acquired by encrypting recovery registration input information being biometric information about the registrant by using a secret key;
generate a random number in response to a request from the client;
generate a protected template acquired by concealing the template by using the random number, and transmit the protected template to the client;
acquire, from the client, information about a concealment index that is an index acquired by concealing a degree of similarity between recovery registration input information and recovery collation information being biometric information about an authenticated subject and is calculated based on the recovery collation information and the protected template; and
generate an index acquired by decrypting the concealment index by using a public key associated with the secret key and the random number and perform authentication on the recovery collation information, based on whether the generated index indicates a value within a predetermined range.

8. The collation system according to claim 7, wherein
the client includes:
at least one storage device configured to store instructions; and
at least one processor configured to execute the instructions to:
generate the secret key and the public key;
generate the template by using the secret key; and
transmit the public key to the recovery verification system.

9. A recovery verification method comprising:
a random number generation stage of generating a random number in response to a request from a client;
a protected template generation stage of generating a protected template acquired by concealing a template by using the random number, and transmitting the protected template to the client, the template being acquired by encrypting registration input information being biometric information about a registrant by using a secret key;
an acquisition stage of acquiring, from the client, information about a concealment index that is an index acquired by concealing a degree of similarity between registration input information and collation information being biometric information about an authenticated subject and is calculated based on the collation information and the protected template; and
an authentication stage of generating an index acquired by decrypting the concealment index by using a public key associated with the secret key and the random number, and performing authentication on the collation information, based on whether the generated index indicates a value within a predetermined range.

10. A non-transitory computer-readable medium storing a program causing a computer to execute:
random number generation processing of generating a random number in response to a request from a client;
protected template generation processing of generating a protected template acquired by concealing a template by using the random number, and transmitting the protected template to the client, the template being acquired by encrypting registration input information being biometric information about a registrant by using a secret key;
acquisition processing of acquiring, from the client, information about a concealment index that is an index acquired by concealing a degree of similarity between registration input information and collation information being biometric information about an authenticated subject and is calculated based on the collation information and the protected template; and
authentication processing of generating an index acquired by decrypting the concealment index by using a public key associated with the secret key and the random number, and performing authentication on the collation information, based on whether the generated index indicates a value within a predetermined range.
